(19) United States
(12) Patent Application Publication
(10) Pub. No.: US 2026/0330961 A1
(43) Pub. Date: Oct. 22, 2026

(54) PENNANT WITH DIRECT COMMUNICATIONS

(71) Applicant: Tyco Fire & Security GmbH, Neuhausen am Rheinfall (CH)

(72) Inventors: Steven Ian BENNETT, Sunbury (GB); Moosa Farook MEAH, Woking (GB); Robert FELTHAM, Fort Lauderdale, FL (US)

(21) Appl. No.: 19/646,306

(22) Filed: Apr. 13, 2026

Related U.S. Application Data
(60) Provisional application No. 63/789,854, filed on Apr. 16, 2025.

(51) Int. Cl. G08B 29/20

(52) U.S. Cl. CPC G08B 29/20

(57) ABSTRACT

Example implementations include an addressable device that is removably mountable onto a base unit in a system. The removable addressing device comprises at least one memory storing one or more addresses for the addressable device in the system. When a device head and the removable addressing device are mounted onto the base unit, the device head is electrically connected with the removable addressing device and is configured to read the one or more addresses stored on the at least one memory of the removable addressing device.

### CROSS-REFERENCE TO RELATED APPLICATION(S)

This application claims the benefit of U.S. Non-Provisional Patent Application No. 63/789,854, entitled “PENNANT WITH DIRECT COMMUNICATIONS” and filed on Apr. 16, 2025, which is expressly incorporated by reference herein in its entirety.

### FIELD

The present disclosure relates generally to security/automation systems, and more particularly, to addressable devices in security/automation systems.

### BACKGROUND

Fire alarm systems are commonly installed in inhabited structures such as dwellings, commercial, industrial, governmental, and/or others to provide safety to inhabitants and/or occupants. Fire alarm systems can include one or more detectors (e.g., thermal and/or smoke detectors), notification appliances (e.g., audio and/or visual notification devices), call points (e.g., communications equipment), other ancillary modules, and/or control panels. These devices can be connected via one or more wiring loops, and one or more of these devices can include a fixed base unit that is installed and/or connected to one or more wiring loop. A removable head unit can be coupled with a fixed base unit such that the removable head unit can be removed and/or replaced for required maintenance and/or upgrades. Knowledge of which devices are installed on particular loop(s) and their locations is utilized in order to maintain proper functioning of the systems and to ensure proper safety is provided for the inhabited structure in which they are installed. Accordingly, addressing schemes have been developed that appropriately identify and catalog each device.

Yet, improvements in addressable devices in security/automation systems are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Traditional addressing mechanisms include the use of a DIP or rotary switch, which fails to do not eliminate duplicate addresses during system installation. Further, traditional mechanisms include two wires that can slide into the bottom of a detector.

In various aspects, an address pennant (also referred to herein as a pennant or tag) can be a module that includes one or more microprocessors that includes a mechanism for maintaining and/or providing a loop address on a base for a detector or other device that supports a serial protocol (e.g., an AUX serial protocol). Detectors that are configurable for use with a pennant can include one or more slots in the base where the pennant (e.g., in the form of a card) can be inserted. When inserted, the pennant can make electrical contact with a minimum of two electrical contacts (e.g., spring force electrical contacts) that are operable to retain the card. A plastic locking detent can also be included in addition to the electrical contacts in order to maintain pennant in an installed location such that it has an operable electrical connection. Other devices that are configurable with a pennant can include identical or similar mounting mechanisms.

In various aspects, a two-wire interface can be provided that includes one line wire as a ground line and one wire as a power line. The power line can be provided on an L2/AUX line from the next generation detector (NGD) head. The power line can be electrically coupled and/or connected to a voltage at the common collector (VCC) pin via a diode and can be electrically coupled and/or connected directly to a universal asynchronous receiver-transmitter (UART) transmitter (TX) line and a general-purpose input/output (GPIO) pin on the microprocessor. The GPIO can be used to monitor a state of the TX line (e.g., high or low) and can be used to configure the pennant in Half-Duplex or Full Duplex Serial mode. The L2/AUX line can be communicatively coupled and/or connected to a diode feeding a reservoir capacitor that is configured to maintain power to the microprocessor when receiving data in Half-Duplex mode as the signal powering the unit is received from a processor transmit pin in the NGD head.

Removable addressing devices can be configured to use serial interface protocol (e.g., an MX-AUX Serial Interface Protocol) specification and issue pennant specific commands (e.g., by pennant address) to enable communications between the pennant and the NGD and, in the case of a 3-wire pennant, to the loop when no NGD head is installed on the base.

An example implementation includes an addressable device comprising a base unit mountable on a structure and a device head removably mountable onto the base unit. A removable addressing device is removably mountable onto the base unit and comprises a processor and at least one memory storing one or more addresses associated with the addressable device. When the removable addressing device is mounted onto the base unit, the address of the removable addressing device is configured to be read from at least one memory of the removable addressing device. The addressable device further comprises a first electrical contact operable to be coupled with an electrical ground, a second electrical contact operable to be coupled with an electrical power line, and a third electrical contact operable to provide the communication with the fire detection loop with and without a device head being installed at a base unit, wherein the addressable device is removably mountable on the base unit of the fire detection loop.

Another example implementation includes a removable addressing device comprising at least one memory storing one or more addresses associated with an addressable device. The removable addressing device is removably mountable onto a base unit of the addressable device. The base unit is mountable on a structure. The addressable device further comprises a device head that is removably mountable onto the base unit. When the removable addressing device is mounted onto the base unit, the removable addressing device is electrically connected to the base unit and the one or more addresses are readable and stored on the at least one memory of the removable addressing device.

A further example implementation includes a base unit of an addressable device. The base unit comprises a receiving portion configured for removably mounting a removable addressing device thereonto. The removable addressing device comprises at least one memory storing one or more addresses for the addressable device. The base unit is mountable on a structure. A device head of the addressable device is removably mountable onto the base unit. When the device head and the removable addressing device are mounted onto the base unit, the device head is electrically connected to the removable addressing device and is configured to read the one or more addresses stored on the at least one memory of the removable addressing device.

An example implementation includes the addition of a third connection to a pennant that allows communications between the pennant and a panel or other associated reader, as well as the pennant and the head. This allows the panel or other associated reader to search or set the addresses on a loop and eliminate errors during system installation, and verifies system configuration prior to installation of the head. In some aspects, this averts issues that can include dirt or other contamination during system installation. Inclusion of a reed switch on the pennant can allow means to define a physical installation location of the device. Additional data such as point and zone string can be included as a function of this process. The pennant can include dual modes, first during install and second in communicating to a head unit. Pennants can be used in other appropriate implementations including lighting, unique device setup, speakers, or others. In some aspects, the panel or other associated reader may assign operating addresses based on a unique serial number of each pennant or via a digital enrollment process conducted over the loop.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram showing a known fire alarm system;

FIG. 2 is an isometric view of an example addressable device having a base unit configured for mounting a removable addressing device thereon, according to some aspects;

FIG. 3A is a top view of the base unit of FIG. 2, according to some aspects;

FIG. 3B is a top view of the base unit of FIG. 2 with a removable addressing device mounted thereon, according to some aspects;

FIG. 4A is a top view of an example address pennant according to some aspects;

FIG. 4B is a bottom view of an example address pennant according to some aspects;

FIG. 5 is a schematic electric wiring diagram of the example addressable device of FIG. 2, according to some aspects; and

FIG. 6 is a block diagram of an example computing device which may implement all or a portion of an addressable device, according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Some present aspects implement a removable and electrically readable addressing device in a base unit onto which a device head of an addressable device of a security/automation system is mounted. The device head, which is powered by electricity, determines the device address by running an electric current through the addressing device to read one or more addresses stored on the addressing device in the base unit of the device. If the device head must be replaced, the device address remains with the base unit, thus no further addressing configurations are needed upon replacement of the device head. Also, since the addressing device is removably implemented in the base unit, an installer may change the device address by removing the addressing device from the base unit, swapping or re-configuring the addressing device, and then plugging the swapped or re-configured addressing device back into the base unit. In other words, the addressing device is configured to communicate with a fire alarm system when the device head is not installed. Some aspects may use a tool (e.g., a device including a software tool) to update the one or more addresses stored on the addressing device if needed. In some aspects, the removable addressing device may be configured as a removable address pennant, e.g., a card-shaped device which may also visually indicate the address on one or more labels printed thereon.

In some aspects, the device head may include, for example but not limited to, a sensor/detector unit or a notification unit in an emergency alarm system and/or a security/automation system. For example, the device head may include an emergency alarm system peripheral such as a hazard detector (including but not limited to a smoke, heat, carbon monoxide (CO), carbon dioxide (CO2), flame, natural gas, or another toxic or noxious chemical detector, a pull station, etc.), an intrusion detector (including but not limited to window and door contacts, glass break sensors, water or water level sensors, passive infra-red (IR) detectors, cameras, sound sensors, motion detectors, etc.), or a notification appliance (including but not limited to sirens, voice alerts, strobes, etc.).

For example, in some non-limiting aspects, the addressable device may be a fire alarm peripheral such as an activation or notification device. The fire alarm peripheral may include a base unit that is permanently installed on a wall or ceiling, and a device head which mounts onto the base unit. The addressing device in the base unit may be used for setting a unique address for the addressable device in a security/automation system that includes multiple addressable devices, so that each addressable device in the security/automation system may be uniquely and individually recognized and addressed. In one non-limiting aspect, for example, the security/automation system may include a loop of up to 250 fire alarm sensors/notification devices (e.g., a pair of wires may provide power and signal connectivity between a fire alarm control panel and up to 250 fire alarm peripherals), where each sensor/device is configured with a unique address. In one non-limiting aspect, for example, the addressable devices in the security/automation system may include emergency alarm system peripherals (such as hazard detectors, intrusion detectors, notification appliances, etc.) that each include a device head mounted onto a base unit that is permanently installed on a wall or ceiling. In these aspects, the addressing devices provided herein easily and efficiently assign an address to each of the emergency alarm system peripherals.

In one non-limiting aspect, for example, the addressing device may be implemented as an address pennant using a relatively small, inexpensive printed circuit board assembly (PCBA) that includes an integrated circuit (IC) with an electrically erasable reprogrammable read only memory (EEPROM). In some aspects, the addressing device can be a processor or a microprocessor that provides a mechanism to provide a loop address on a base for a detector or other head that supports an auxiliary (AUX) serial protocol. Once mounted onto the base unit, the addressing mechanism connects with metal contacts on the base unit, which connect to the fitted sensor head (e.g., using an existing “aux” port), such that the device head can electrically interface with and read the address pennant. The address pennant may be pre-programmed in production with the operating address field, e.g., pre-programmed to one of 250 possible addresses used for sensor heads. In an aspect, the 250 possible addresses, or a subset of them, may be packaged into smaller groups and shipped to installers. Accordingly, an installer may pick an address pennant with a desired address and slide the address pennant into a base unit. In some aspects, printing, marking, or imprinting may be implemented on the visible side of the address pennant, which may be the side of the address pennant that does not include surface mount devices (SMDs), to allow for visible indication of the pre-programmed address. Further, the address pennant may also be extended to allow for visible indication of the address on a flag protruding outside of the base unit. In these aspects, the address pennant may include holes, which may be referred to as “mouse bites,” or perforations to enable a user/installer to break off the extended portion if desired. For example, the address pennant may include the holes/perforations to facilitate easy breakoff of the unwanted portion of the PCBA. In some aspects, the base unit may include one or more mechanical features to retain the address pennant in the base unit once installed. For example, the address pennant may have an aperture such that the address pennant is locked into place using a flexible clip.

In some aspects the address pennant can be a card that is installed and/or inserted in a slot and/or other receiver configured to operably receive the address pennant. The addressing pennant can make and maintain electrical contact with two or more spring force electrical contacts that retain the card. In some aspects, an additional locking detent can be provided that also operably holds the card in place while the electrical contacts provide an electrical connection.

Some existing systems may implement an addressing device in the device head. In these systems, when the device head is swapped/exchanged, the device address needs to be configured in the new device head. Unlike the aforementioned systems, the addressing device according to the present aspects is implemented in the base unit and stays with the base unit during replacement of the device head.

Some existing systems may implement a non-removable addressing device in the base unit of a device. In these systems, the base unit may be placed on a ceiling or high up on a wall, thus causing difficulty for an installer to change the address when necessary. Unlike the aforementioned systems, the present aspects allow for an installer to remove the addressing device from the base unit, swap or re-configure the addressing device, and then plug the swapped or re-configured addressing device back into the base unit that is located on a ceiling or high up on a wall.

Some existing systems implement an addressing device that requires a special physical tool and a conversion table to set the address. For example, some systems implement an addressing device in the base unit or in the device head, where the addressing device includes as array of binary dual in-line package (DIP) switches that can be configured using a special tool and a binary-to-decimal conversion table. However, the addressing device according to the present aspects includes a pre-programmable memory storing one or more addresses, therefore not requiring a physical tool/conversion table and not requiring field programming.

The present aspects provide a fully electronic addressing device that does not require another printed circuit board (PCB) functionality in the base unit. The addressing device according to some present aspects is backward/forward compatible with existing sensor heads and base units, such as, for example but not limited to, Generation 6 MX detector bases manufactured by TYCO Fire Protection Products and ZETTLER Fire Detection Products and Systems, detector bases manufactured by Simplex, Autocall, Fireclass, Vigilant, DBE, etc.

In some aspects, the addressing device may store other system information locally, such as the type of device head previously fitted, location information (e.g., point/zone string), the serial number of the base unit, etc. For example, a QR code configured on the removable addressing device 106 may encode the serial number or other production data stored locally on the removable addressing device 106, enabling retrieval of such information by scanning the QR code with a general-purpose device.

In some aspects, the address field in the addressing device may be changeable/reconfigurable via the device head controlled by a control panel or by a special tool/device, if required.

Turning now to the figures, example aspects are depicted with reference to one or more components described herein, where components in dashed lines may be optional.

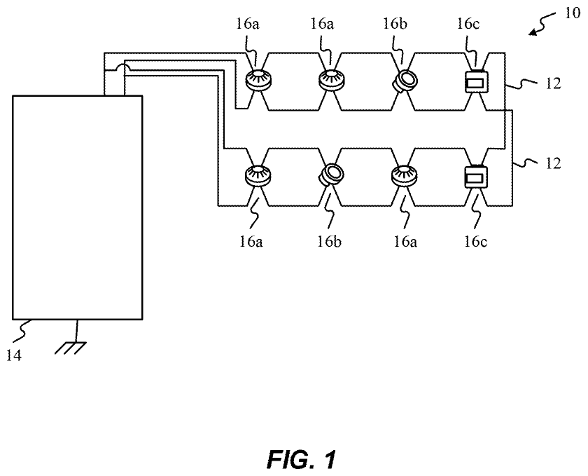

FIG. 1 is a block diagram showing a fire alarm system 10, which may be installed in a premises, such as office buildings, factories, homes, and the like, and typically include a fire alarm control panel 14 (often known as control and indicating equipment, CIE), a plurality of detectors 16a, a plurality of notification appliances 16b, and wiring 12 connecting detectors 16a and notification appliances 16b to fire alarm control panel 14. Fire alarm system 10 can also include call points 16c and a range of other ancillary modules. In many cases, wiring 12 which is installed is a 2-wire addressable loop, and detectors 16a, notification appliances 16b, call points 16c, and other ancillary modules (hereafter referred to as “devices 16”) are arranged on the loop and connected across its two wires. Multiple loops are generally installed and connected to fire alarm control panel 14, with each loop typically carrying devices 16 to a different part of the premises. The loops typically provide power to devices 16 on the loop and convey instructions and data from fire alarm control panel 14 to the individual devices 16, such as configuration data to all devices 16 or an alarm signal to the notification appliances 16b, and convey data from devices 16 to fire alarm control panel 14. Where a device 16 is a detector 16a, such detector 16a generates a detector value corresponding to what the detector 16a is sensing, and the loop conveys the detector value to the fire alarm control panel 14. Other devices 16 might also generate values. The looped arrangement via wiring 12 provides resilience to a break in an individual loop occurring during operation, and a voltage level between wires 12 in the loop can be maintained at a sufficient level (e.g., sufficiently high) to sustain all devices 16 around the complete loop. A single fire alarm control panel 14 can support multiple loops of addressable devices 16 with appropriate installation and wiring.

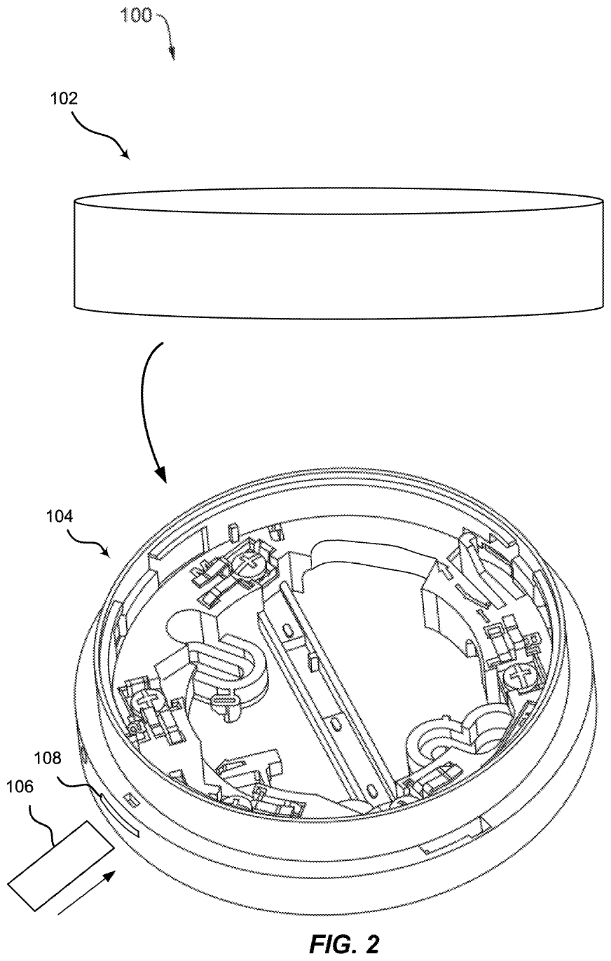

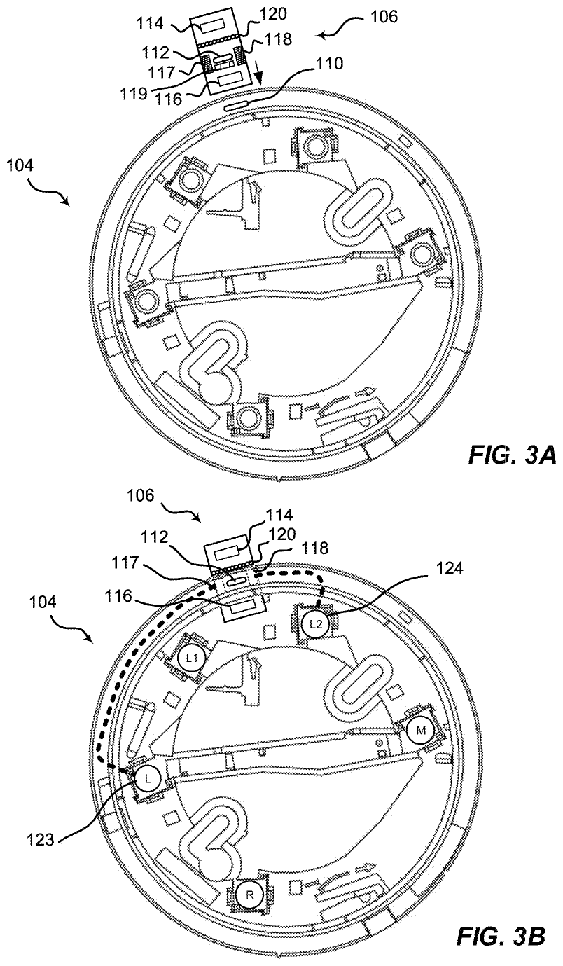

Referring to FIGS. 2, 3A, and 3B, an addressable device 100 includes a base unit 104 and a device head 102 removably mountable onto the base unit 104. The addressable device 100 may include, for example but not limited to, a sensor/detector unit or a notification unit in an emergency alarm system and/or a security/automation system. For example, the addressable device 100 may include an emergency alarm system peripheral such as a hazard detector (including but not limited to a smoke, heat, CO, CO2, flame, natural gas, or another toxic or noxious chemical detector, a pull station, etc.), an intrusion detector (including but not limited to window and door contacts, glass break sensors, water or water level sensors, passive IR detectors, cameras, sound sensors, motion detectors, etc.), or a notification appliance (including but not limited to sirens, voice alerts, strobes, etc.). The base unit 104 may be mounted on a wall or ceiling. The device head 102, which houses the actual sensor(s), notification transponder(s), etc., of the addressable device 100, is mounted onto the base unit 104 during installation or replacement of the addressable device 100.

While some aspects below may be directed to smoke detectors, the present aspects are not so limited and are applicable to other systems where addressable devices are fixed to building walls or ceiling or other structures, for example, but not limited to, notification appliances or other emergency detectors or annunciators, home automation devices, etc. In some aspects, the terms “head unit,” “device head,” “detector head,” and “sensor head” may refer to the transponder part of a notification appliance device that can attach to a base unit of the device.

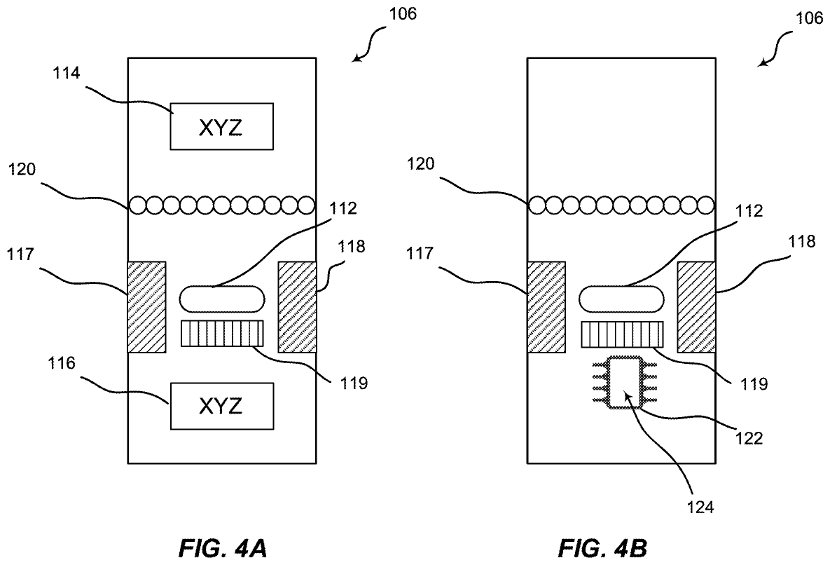

The base unit 104 of the addressable device 100 includes a removable addressing device 106 having one or more addresses of the addressable device 100 stored thereon. The one or more addresses (e.g., two addresses, three address, or another quantity of addresses) stored on the removable addressing device 106 in the base unit 104 is electrically readable by the device head 102. The removable addressing device 106 may be implemented as a removable address pennant, e.g., a card-shaped device which may also visually indicate the address on one or more labels printed thereon (see FIGS. 4A and 4B).

In some aspects, a base unit 104 can have an address, a device head 102 can have an address, and/or a removable addressing device 106 can have an address. In such aspects, removable storage device 106 can store each address (i.e. the address associated with base unit 104, the address associated with device head 102 and/or the address associated with removable addressing device 106). These addresses can be associated with each other in storage (i.e., in close proximity in a location in memory, via pointer(s), or otherwise associated), so that they can are cross-referenced with each other and if an error, fault, or other issue occurs, base unit 104, device head 102, and/or a removable addressing device 106 can be adequately serviced and/or replaced.

In aspects where an address for a device head 102 is stored on removable storage device 106, such address can be read from device head 102 and/or sent to removable storage device 106 for storage. In aspects where an address for a base unit 104 is stored on removable storage device 106, such address can be read from base unit 104 and/or sent to removable storage device 106 for storage.

In some aspects, a base unit 104 and/or device head 102 can include one or more functions (e.g., one or more sensing functions, alarms, notifications, audio and/or video feeds, or other functions). Data and/or information associated with one or more of these functions can be stored in a register in memory of the removable addressing device 106. This data and/or information can also be accessible (e.g., read from the memory of the removable addressing device 106 over the loop, when the removable addressing device 106 is removed, or via another appropriate accessing and/or reading from memory) and can provide an indication the type of device (e.g., base unit 104 and/or device head 102) that the data and/or information is associated with.

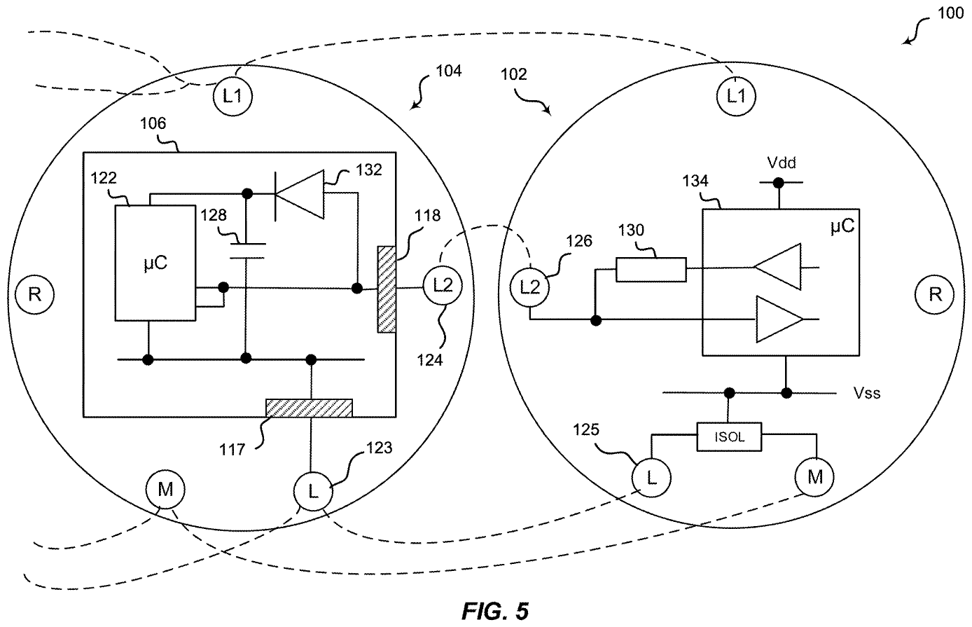

In one non-limiting aspect, for example, the device head 102 is alignable with the base unit 104 so that, when properly aligned, the device head 102 electronically connects with the removable addressing device 106 in the base unit 104 and reads the one or more addresses stored on the removable addressing device 106 (further details are provided below with reference to FIG. 5). Since the addressing device 106 is removable from the base unit 104, an installer may change the address of the device 100 by swapping or reconfiguring the addressing device 106 and then inserting the swapped or re-configured addressing device 106 into the base unit 104.

In an aspect, the removable addressing device 106 includes a PCBA and can be insertable into a receiving portion 108 (see FIG. 2) of the base unit 104 (where the receiving portion 108 may be a slot configured on an outer surface of the base unit 104 as in the example aspect of FIG. 2). In some aspects, once inserted, the removable addressing device 106 may lock into the base unit 104. For example, the base unit 104 may have a feature to hold and lock the removable addressing device 106 within the receiving portion 108 (e.g., a slot), such as but not limited to a clip, latch, or detent. Subsequent to insertion and locking, the removable addressing device 106 may later be removed by unclipping the feature with a simple tool (e.g., a screwdriver).

In an aspect, for example, the removable addressing device 106 may lock into the base unit 104 when a tab 110 (or latch, or other detent) configured in the base unit 104 (see FIG. 3A) engages into a corresponding opening 112 configured in the removable addressing device 106 (see FIGS. 3A and 3B). It should be understood that additionally or alternatively, a tab, latch, or other detent could be configured in the removable addressing device 106 and a corresponding opening could be configured in the base unit 104. In any case, such locking may also improve the electrical connection of the removable addressing device 106 with the base unit 104 and the device head 102. In some aspects, base unit 104 may include leaf spring electrical contacts or other electrical contacts that further help in holding the removable addressing device 106 in place.

The present aspects allow for a removable addressing device 106 such as a removable address pennant to be implemented as a common part that can be shipped to various job sites. Accordingly, the removable addressing device 106 according to the present aspects provides a low-cost addressing device which does not require assembly and can be quickly and readily replaced in the field with minimal complexity.

In some aspects, the value of the one or more addresses stored on the removable addressing device 106 may be visibly indicated on a first label 116 and/or a second label 114 configured on a top surface of the removable addressing device 106 (see FIGS. 3A, 3B, and 4A, wherein in FIG. 4A the value of the address is indicated by the characters “XYZ” but it should be understood that any readable mechanism may be used to indicate the address, e.g., alphanumeric characters, numbers, colors, bar code, QR code, or any combination thereof). In some aspects, a QR code may be configured on the removable addressing device 106 and may encode production data associated with the removable addressing device 106, such as the serial number of the removable addressing device 106, one or more type identifiers, one or more date codes, and/or other manufacturing or production information. The QR code may be scanned using a general-purpose device (e.g., a smartphone or tablet) to look up or log details associated with the removable addressing device 106 without requiring a special tool or proprietary reader.

The first label 116 may be placed such that, when the removable addressing device 106 is mounted onto the base unit 104, the first label 116 is visible inside the base unit 104 (see FIG. 3B). The second label 114 may be placed such that, when the removable addressing device 106 is mounted onto the base unit 104, the second label 114 is visible outside the base unit 104 (see FIG. 3B). In some aspects, a portion of the removable addressing device 106 that includes the second label 114 may be breakable such that an installer may remove that portion by breaking along corresponding perforations 120 (e.g., mouse bite holes, see FIGS. 3A, 3B, 4A, and 4B) configured in the removable addressing device 106.

In some aspects, the removable addressing device 106 includes a printed circuit board assembly (PCBA) that includes a memory 122 (see FIG. 4B) that stores the one or more addresses of the device 100. In an aspect, the memory 122 may be a read only memory (ROM). In an aspect, the memory 122 may be an electrically erasable reprogrammable read only memory (EEPROM). In some aspects, the PCBA of the removable addressing device 106 may be protected against humidity via a coating layer, e.g., an epoxy-based, acrylics, etc. coating layer.

The removable addressing device 106 can include one or more processor(s) 124 and can include a reservoir capacitor for power. For internal communications to the NGD, the removable addressing device 106 can be connected to L2 (AUX) and ground. The removable addressing device 106 can have a serial number, such as a four-byte Production Serial Number (PSN) set during manufacturing, that can be used to filter commands sent to a specific removable addressing device 106. Manufacturing and the NGD can support removable addressing device 106 specific commands using the AUX interface. Software for the removable addressing device 106 can include support commands to read/write the Address and the PSN into pseudo EEPROM inside the removable addressing device 106, as well as a protection bit.

Typically, AUX devices are powered by the loop with their own power supply circuitry. A two wire version of the removable addressing device 106 can be powered by the L2 pin from the NGD and is powered by a reservoir capacitor. The L2 line is asserted high on power-up which will charge the reservoir capacitors in the removable addressing device 106. There can be a power-on delay before communications with the removable addressing device 106 begin in order to ensure a stable power reservoir has been reached on the removable addressing device 106. This delay period (e.g., in milli-seconds) can be defined in an initial delay register inside the NGD.

The removable addressing device 106 can be considered a fifth AUX device and can require no configuration data to be sent to it during initialization. The data read from the removable addressing device 106 can be associated with a fifth set of AUX registers. In some aspects, removable addressing devices 106 can be hard coded with a device type value in firmware. In some aspects, printed removable addressing devices 106 can be programmed with a matching printed address. Blank removable addressing devices 106 can include a default loop address. Other AUX devices can be assigned a unique device type.

On power up, if a specific bit has a particular value (e.g., specific bit equals 0), this can indicate hard addressing. Alternatively or additionally, if a specific bit has a particular value (e.g., specific bit equals 1), this can indicate a setting to read the removable addressing device 106. Then a NGD can start an AUX serial process to read a loop address from the removable addressing device 106 inserted in the base unit 104.

Once an optional waiting period has expired, the NGD can send a request to the removable addressing device 106. The removable addressing device 106 can reply with a loop address (e.g., in a first reply byte or second reply byte). The NGD can store the reply data in one or more registers (e.g., in RAM) respectively in the NGD.

In some aspects, operating addresses may be assigned to the removable addressing device 106 based on a unique serial number (e.g., the PSN) of the removable addressing device 106 or via a digital enrollment process over the loop. For example, the panel or a tool (e.g., a commissioning tool connected to the loop) may query each removable addressing device 106 for its unique serial number and, based on the serial number, assign a corresponding operating loop address to the removable addressing device 106. Alternatively, the panel or tool may perform a digital enrollment procedure in which each removable addressing device 106 connected to the loop is discovered, registered, and assigned an operating address without requiring manual address entry or physical manipulation of the removable addressing device 106.

Once a loop address has been read and applied to the NGD, the NGD can send a command and/or request for the PSN of the removable addressing device 106. The removable addressing device 106 can reply with the. The NGD can store this in one or more registers.

When the NGD successfully reads the MX loop address from a removable addressing device 106, the read MX loop address can be compared to a current value in the AUX removable addressing device 106 Backup register. If the read address value is different than the saved value, the new read value can be saved in the NGD AUX removable addressing device 106 Backup register. The NGD can also apply the new MX loop address to the NGD to be used to respond to all future panel commands that match the new address instead of the previous address.

Numerous events can cause the removable addressing device 106 to be read. It can be read on loop power up, if a device head 102 is removed and reconnected to either the same base or a different base, if a software reset in the NGD is executed, if a panel on the loop sends a status command to the NGD, or any other condition that causes the head to restart operations.

In cases where the removable addressing device 106 cannot be read, the NGD can use a loop address in an AUX pennant backup register, if it is a valid address (e.g., from 1-250). If this address is not a valid address, (e.g., from 0 or 251-255), the NGD can use a factory default address (e.g., 255). The NGD can then report a pennant missing status using either a valid backup address or a default factory address of 255 when the removable addressing device 106 is polled.

Pennants(e. g,, removable addressing devices 106) can be programmed before installation and can be optionally labeled with a loop address. They can also be used to query devices in order to test integrity of the loop, poll each base unit, confirm each responds with a proper address, and be used for reconfiguration if required.

On initial power up if the pennant is enabled and unable to be read or is missing short status registers (e.g., AUX REG DATA 1 & 2), the registers can be cleared to indicate no response. The NGD MX loop address can use the default factory MX loop address.

In both fault cases an AUX trouble indication status can be raised to the panel by setting an error register bit to indicate a missing Pennant and a fault bit can be set in a reply message header from the NGD for the address being used, (either 255 or the last saved valid back up address).

FIG. 5 is a schematic electrical wiring diagram of an aspect of the addressable device 100 in which the device head 102 and the base unit 104 have a matching set of power terminals, e.g., terminals “L,” “L1,” “L2,” “M,” and “R” as in Generation 6 MX systems. It should be noted that the illustrative arrangement/order of terminals “L,” “L1,” “L2,” “M,” and “R” in the base unit 104 in FIG. 5 does not match the physical arrangement/order of terminals “L,” “L1,” “L2,” “M,” and “R” illustrated in the top view of the base unit 104 in FIG. 3B. Instead, in FIG. 5, terminals “L,” “L1,” “L2,” “M,” and “R” in the base unit 104 are arranged in a way that improves the clarity of illustration of the electrical connections (as indicated by dashed lines) between the device head 102, the base unit 104, and the removable addressing device 106. As described previously, the device head 102 is alignable with the base unit 104 so that, when properly aligned, the device head 102 electronically connects with the removable addressing device 106 in the base unit 104 and reads the one or more addresses stored on the removable addressing device 106.

Referring back to FIGS. 4A and 4B, the removable addressing device 106 may include a first electrical contact 117, a second electrical contact 118, and a third electrical contact 119 that provide electrical connection to the memory 122 and/or power-line communication. It should be noted that in some aspects first contact 117, second contact 118, and/or third electrical contact 119 may be provided on one or more surfaces of the removable addressing device 106 (e.g., on a top surface as in FIG. 4A and/or on a bottom surface as in FIG. 4B), so that the removable addressing device 106 may be inserted into base unit 104 with either a top or bottom surface facing up.

Third electrical contact 119 can be configured to allow removable addressing device 106 to be powered from the loop it is coupled with and/or connected to when third electrical contact 119 on removable addressing device 106 is inserted, coupled, connected, and/or otherwise operably installed in base unit 104. In some aspects, this powering is operable when no device head 102 is installed. Third electrical contact 119 can be configured to allow address verification and/or updating to be performed prior to device head 102 being installed. In this configuration base unit 104 can be operable to regulate loop voltage (e.g., at 3.3 volts). Data can be transmitted (e.g., ASCII Data, at 1200 BAUD) on the loop using a data transmission protocol (e.g., AUX protocol), and pennant specific commands using loop interface circuitry to send and/or receive data. In some aspects, when no device head 102 is installed, the loop voltage is maintained at a level that is sufficient to close loop isolators, thereby enabling the panel or tool to communicate with each removable addressing device 106 connected to the loop through the isolators.

In some aspects, the data transmission protocol used for communication between the removable addressing device 106 and the panel or tool over the loop may be a simplified or slowed version of the standard communication protocol (e.g., a simplified or slowed version of the AUX protocol) in order to reduce hardware interfacing cost on the removable addressing device 106. Loop commands can be sent to verify and set loop addresses of each pennant. For pennants with three-wire configurations, an electrically connected loop can be configured to power the pennant continuously. The three-wire pennant can operate in various instances, for example in Half-Duplex when device head 102 is operably installed and in Full-Duplex when no device head 102 is operably installed.

When a head is operably installed, an L2/TX connection can operate high on a GPIO Pin for monitoring a mode state and setting the mode state to Half-Duplex mode. When the head is not operably installed the L2/TX line is configured to operate low by loop interface circuitry pulling the mode-state pin low, setting the tag to Full-Duplex.

Referring again to FIG. 5, when the removable addressing device 106 is mounted onto the base unit 104, the first contact 117 and the second contact 118 of the removable addressing device 106 electrically connect with respective ones of a third contact 123 and a fourth contact 124 of the base unit 104. In an aspect, the third contact 123 and the fourth contact 124 may be the “L” and “L2” terminals of the base unit 104, respectively, and may be configured as leaf spring contacts. Further, when the device head 102 is mounted onto the base unit 104, the third contact 123 and the fourth contact 124 electrically connect with respective ones of a fifth contact 125 and a sixth contact 126 of the device head 102. In an aspect, the fifth contact 125 and the sixth contact 126 may be the “L” and “L2” terminals of the device head 102, respectively, and may be configured as leaf spring contacts. Accordingly, when the removable addressing device 106 and the device head 102 are mounted onto the base unit 104, the first contact 117 and the second contact 118 of the removable addressing device 106 are electrically connected with the fifth contact 125 and the sixth contact 126 of the device head 102, respectively.

Once connected, the “L” terminal is used as the master negative reference, while the “L2” terminal is used for data and voltage/power connection between the base unit 104 and the device head 102. More specifically, the device head 102 may use power-line communication over the “L2” terminal to read the address data for one or more addresses stored on the memory 122. A capacitor 128 may be connected between the negative reference line and the power/data line of the memory 122 to hold up the voltage during the communications so that the memory 122 does not brown out (e.g., does not lose power). A diode 132 may be implemented between the second contact 118 and the memory 122 in the removable addressing device 106 in order to prevent rapid discharging of the capacitor 128 when a low-level logic signal is being transmitted (either from a microcontroller 134 in the device head 102 or from a microcontroller in the removable addressing device 106 (e.g., from the memory 122)). A resistor 130 may be implemented between the “L2” terminal and an output line of the microcontroller 134 in the device head 102 so that a microcontroller of the removable addressing device 106 (e.g., the memory 122) can override the control line in order to return data from the removable addressing device 106 to the device head 102.

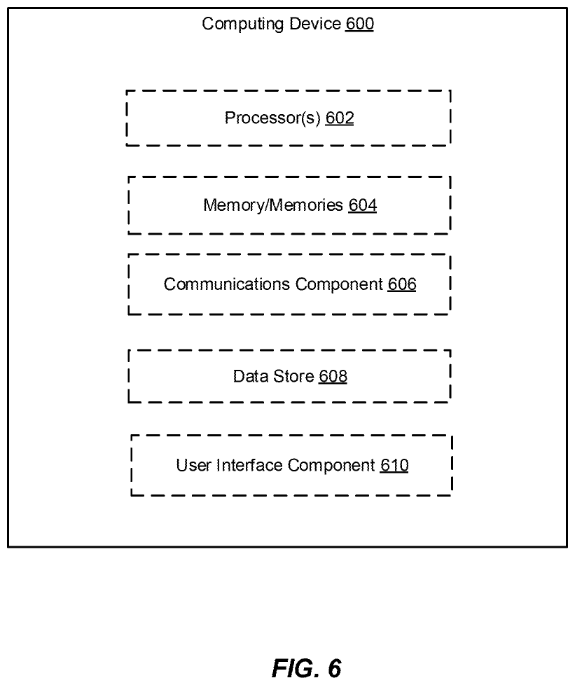

FIG. 6 illustrates an example block diagram providing details of computing components in a computing device 600 that may implement all or a portion of one or more components in an addressable device 100 or any other component described above. The computing device 600 may include one or more processors 602 which may be configured to execute or implement software, hardware, and/or firmware modules that perform any functionality described above with reference to one or more components in an addressable device.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The one or more processors 602 may include a micro-controller and/or may include a single or multiple set of processors or multi-core processors. Moreover, the one or more processors 602 may be implemented as an integrated processing system and/or a distributed processing system. The computing device 600 may further include one or more memories 604, such as for storing local versions of applications being executed by the one or more processors 602, related instructions, parameters, etc. The one or more memories 604 may include a type of memory usable by a computer, such as random access memory (RAM), read only memory (ROM), tapes, flash drives, magnetic discs, optical discs, volatile memory, non-volatile memory, and any combination thereof. Additionally, the one or more processors 602 and the one or more memories 604 may include and execute an operating system executing on the one or more processors 602, one or more applications, display drivers, etc., and/or other components of the computing device 600.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, In combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Further, the computing device 600 may include a communications component 606 that provides for establishing and maintaining communications with one or more other devices, parties, entities, etc., utilizing hardware, software, and services. The communications component 606 may carry communications between components on the computing device 600, as well as between the computing device 600 and external devices, such as devices located across a communications network and/or devices serially or locally connected to the computing device 600. For example, the communications component 606 may include one or more buses, and may further include transmit chain components and receive chain components associated with a wireless or wired transmitter and receiver, respectively, operable for interfacing with external devices.

In some optional aspects, the computing device 600 may additionally include a data store 608, which can be any suitable combination of hardware and/or software, that provides for mass storage of information, databases, and programs. For example, the data store 608 may be or may include a data repository for applications and/or related parameters not currently being executed by the one or more processors 602. In addition, the data store 608 may be a data repository for an operating system, application, display driver, etc., executing on the one or more processors 602, and/or one or more other components of the computing device 600.

Also, in some optional aspects, the computing device 600 may additionally include a user interface component 610 operable to receive inputs from a user of the computing device 600 and further operable to generate outputs for presentation to the user (e.g., via a display interface to a display device). The user interface component 610 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 610 may include one or more output devices, including but not limited to a display interface, a speaker, a haptic feedback mechanism, a printer, any other mechanism capable of presenting an output to a user, or any combination thereof.

In some aspects, peer to peer AUX interface could be included. This can allow pennant devices to communicate on the loop and disable communications if they share duplicate addresses, which can be discovered based on comparisons.

Some further example aspects of the devices described herein are provided in the following clauses.
1. An addressable device, comprising: An addressable device for communication with a fire detection loop, comprising:
   a processor;
   at least one memory storing one or more addresses associated with the addressable device;
   a first electrical contact operable to be coupled with an electrical ground;
   a second electrical contact operable to be coupled with an electrical power line; and
   a third electrical contact operable to provide the communication with the fire detection loop with and without a device head being installed at a base unit,
   wherein the addressable device is removably mountable on the base unit of the fire detection loop.
2. The addressable device of clause 1, wherein the memory stores a plurality of addresses, including an address associated with the base unit and the head unit.
3. The addressable device of clause 1 or 2, wherein the at least one memory comprises a register that stores data associated with one or more functions of the base unit.
4. The addressable device of any one of the above clauses, wherein the addressable device is an address pennant having a first surface and a second surface, wherein, when the addressable device is mounted onto the base unit, at least a first portion of the first surface is visible inside the base unit.
5. The addressable device of clause 4, wherein the address is visibly indicated on the first portion of the first surface of the address pennant.
6. The addressable device of clause 4 or 5, wherein the address pennant is configured to be inserted into a slot in the base unit.
7. The addressable device of clause 6, wherein the address pennant comprises an engagement member configured to engage with a receiving member of the base unit when the address pennant is inserted into the slot.
8. The addressable device of clause 7, wherein the engagement member comprises a tab member or a clip member configured on the first surface of the address pennant.
9. The addressable device of any one of clauses 4 to 8, wherein the address pennant comprises first electrical contacts configured on the first surface and/or on the second surface, wherein the first electrical contacts are electrically connected to the at least one memory of the address pennant.
10. The addressable device of clause 9, wherein, when the removable addressing device is mounted onto the base unit, the first electrical contacts are electrically connected to second electrical contacts configured on the base unit.
11. The addressable device of clause 9 or 10, wherein, when the device head and the removable addressing device are mounted onto the base unit, the first electrical contacts are electrically connected to second electrical contacts configured on the base unit, and the second electrical contacts are electrically connected to third electrical contacts configured on the device head.
12. The addressable device of clause 11, wherein the third electrical contacts are electrically connected to an auxiliary port in the device head.
13. The addressable device of any one of clauses 4 to 12, wherein, when the device head and the addressable device are mounted onto the base unit, the one or more addresses stored on the at least one memory of the address pennant is re-configurable by remotely controlling the device head.
14. The addressable device of any one of clauses 4 to 13, wherein, when the addressable device is mounted onto the base unit, at least a second portion of the first surface is visible outside the base unit, wherein the address is visibly indicated on the first portion and/or on the second portion of the first surface of the address pennant.
15. The addressable device of clause 14, wherein the second portion is breakable from the address pennant.
16. The addressable device of any one of the above clauses, wherein, when the device head and the addressable device are mounted onto the base unit, the device head is electrically connected to the removable addressing device via a first electrical path and a second electrical path.
17. The addressable device of clause 16, wherein the first electrical path is connected to a ground voltage line of the base unit and the device head, wherein the device head is configured to read the one or more addresses stored on the at least one memory of the removable addressing device over the second electrical path using power-line communication.
18. A removable addressing device comprising:
at least one memory storing one or more addresses associated with an addressable device;
a processor;
a first electrical contact configured to be coupled with an electrical ground;
a second electrical contact configured to be coupled with an electrical power line; and
a third electrical contact configured to provide communication via a fire detection loop of the fire detection system before a device head is installed at the base unit.
19. The removable addressing device of clause 18, further comprising a printed circuit board assembly (PCBA) comprising the at least one memory.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An addressable device for communication with a fire detection loop, comprising:
a processor;
at least one memory storing one or more addresses associated with the addressable device;
a first electrical contact operable to be coupled with an electrical ground;
a second electrical contact operable to be coupled with an electrical power line; and
a third electrical contact operable to provide the communication with the fire detection loop with and without a device head being installed at a base unit,
wherein the addressable device is removably mountable on the base unit of the fire detection loop.

2. The addressable device of claim 1, wherein the at least one memory stores a plurality of addresses, including an address associated with the base unit and the device head.

3. The addressable device of claim 1, wherein the at least one memory comprises a register that stores data associated with one or more functions of the base unit.

4. The addressable device of claim 1, wherein the addressable device is an address pennant having a first surface and a second surface, wherein, when the addressable device is mounted onto the base unit, at least a first portion of the first surface is visible inside the base unit.

5. The addressable device of claim 4, wherein the one or more addresses is visibly indicated on the first portion of the first surface of the address pennant.

6. The addressable device of claim 4, wherein the address pennant is configured to be inserted into a slot in the base unit.

7. The addressable device of claim 6, wherein the address pennant comprises an engagement member configured to engage with a receiving member of the base unit when the address pennant is inserted into the slot.

8. The addressable device of claim 7, wherein the engagement member comprises a tab member or a clip member configured on the first surface of the address pennant.

9. The addressable device of claim 4, wherein the address pennant comprises first electrical contacts configured on the first surface and/or on the second surface, wherein the first electrical contacts are electrically connected to the at least one memory of the address pennant.

10. The addressable device of claim 9, wherein, when the removable addressing device is mounted onto the base unit, the first electrical contacts are electrically connected to second electrical contacts configured on the base unit.

11. The addressable device of claim 10, wherein, when the device head and the removable addressing device are mounted onto the base unit, the first electrical contacts are electrically connected to second electrical contacts configured on the base unit, and the second electrical contacts are electrically connected to third electrical contacts configured on the device head.

12. The addressable device of claim 11, wherein the third electrical contacts are electrically connected to an auxiliary port in the device head.

13. The addressable device of claim 4, wherein, when the device head and the addressable device are mounted onto the base unit, the one or more addresses stored on the at least one memory of the address pennant is re-configurable by remotely controlling the device head.

14. The addressable device of claim 4, wherein, when the addressable device is mounted onto the base unit, at least a second portion of the first surface is visible outside the base unit, wherein the one or more addresses is visibly indicated on the first portion and/or on the second portion of the first surface of the address pennant.

15. The addressable device of claim 14, wherein the second portion is breakable from the address pennant.

16. The addressable device of claim 1, wherein, when the device head and the addressable device are mounted onto the base unit, the device head is electrically connected to the removable addressing device via a first electrical path and a second electrical path.

17. The addressable device of claim 16, wherein the first electrical path is connected to a ground voltage line of the base unit and the device head, wherein the device head is configured to read the one or more addresses stored on the at least one memory of the removable addressing device over the second electrical path using power-line communication.

18. A removable addressing device removably mountable on a base unit of a fire detection system, comprising:
at least one memory storing one or more addresses associated with an addressable device;
a processor;
a first electrical contact configured to be coupled with an electrical ground;
a second electrical contact configured to be coupled with an electrical power line; and
a third electrical contact configured to provide communication via a fire detection loop of the fire detection system before a device head is installed at the base unit.

19. The removable addressing device of claim 18, further comprising a printed circuit board assembly (PCBA) comprising the at least one memory.

20. The removable addressing device of claim 18, wherein the at least one memory further stores a unique serial number associated with the removable addressing device, and wherein, when the removable addressing device is mounted onto the base unit and the device head is not installed at the base unit, a panel or a tool communicatively coupled to the fire detection loop is configured to assign the one or more addresses to the removable addressing device based on the unique serial number or via a digital enrollment process conducted over the fire detection loop.
